(19) United States
(12) Patent Application Publication
(10) Pub. No.: US 2026/0267460 A1
(43) Pub. Date: Sep. 10, 2026

(54) INFORMATION PROCESSING METHOD, INFORMATION PROCESSING DEVICE, AND NON-TRANSITORY COMPUTER READABLE STORAGE MEDIUM

(71) Applicant: PANASONIC INTELLECTUAL PROPERTY MANAGEMENT CO., LTD., Osaka (JP)

(72) Inventor: Minami NAKA, Osaka (JP)

(73) Assignee: PANASONIC INTELLECTUAL PROPERTY MANAGEMENT CO., LTD., Osaka (JP)

(21) Appl. No.: 19/659,896

(22) Filed: Apr. 27, 2026

Related U.S. Application Data
(63) Continuation of application No. PCT/JP2024/038600, filed on Oct. 30, 2024.
(60) Provisional application No. 63/546,995, filed on Nov. 2, 2023.

(30) Foreign Application Priority Data
Jun. 10, 2024 (JP) 2024-093948

(51) Int. Cl. G06F 3/04815; G06F 3/04817; G06T 11/60

(52) U.S. Cl. CPC G06F 3/04815; G06F 3/04817; G06T 11/60

(57) ABSTRACT

An information processing method includes: displaying, on a display of a terminal device, a bird's-eye view image on which a plurality of imaging point icons indicating a plurality of imaging points is overlaid; and displaying, on the display, a first image captured at a first imaging point indicated by a first imaging point icon when selection of the first imaging point icon that is one imaging point icon among the plurality of imaging point icons is detected, in which the displaying the first image includes displaying information indicating a second image different from a plurality of images captured at the plurality of imaging points on the first image when the second image is associated with a position within a predetermined range with respect to the first imaging point.

### FIELD OF INVENTION

The present disclosure relates to a technique for displaying images captured at a plurality of imaging points.

### BACKGROUND ART

Patent Literature 1 discloses a technique of displaying an image captured at a first point among a series of a plurality of imaging points, and overlay-displaying an icon indicating an imaging point adjacent to the first point on the image.

However, Patent Literature 1 does not disclose checking the presence or absence of an image related to the periphery of the imaging point of the image being displayed, which is different from the images captured at the plurality of imaging points, while maintaining the display of the image captured at each of the plurality of imaging points. Therefore, in order to implement this in Patent Literature 1, there has been a problem that the number of processing steps increases and the load on the computer increases.
Patent Literature 1: JP 2021-72627 A

### SUMMARY OF THE INVENTION

The present disclosure has been made to solve such a problem, and an object of the present disclosure is to provide a technology capable of confirming the presence or absence of an image related to the periphery of an imaging point of an image being displayed without increasing the number of processing steps.

An information processing method according to one aspect of the present disclosure is an information processing method in a computer, including: displaying, on a display of a terminal device, a bird's-eye view image on which a plurality of imaging point icons indicating a plurality of imaging points is overlaid; and displaying, on the display, a first image captured at a first imaging point indicated by a first imaging point icon when selection of the first imaging point icon that is one imaging point icon among the plurality of imaging point icons is detected, in which the displaying the first image includes displaying information indicating a second image different from a plurality of images captured at the plurality of imaging points on the first image when the second image is associated with a position within a predetermined range with respect to the first imaging point.

### BRIEF DESCRIPTION OF THE DRAWINGS

FIG. 1 is an overall configuration diagram of an information processing system.

FIG. 2 is a diagram illustrating an example of a design drawing displayed on a display of an information terminal.

FIG. 3 is a diagram illustrating an example of a display screen to be displayed on a display when a first imaging point icon is selected.

FIG. 4 is a diagram illustrating an example of a first image.

FIG. 5 is a diagram illustrating another example of a display screen to be displayed on the display when the first imaging point icon is selected.

FIG. 6 is a diagram illustrating an example of a display screen on which a second image is displayed.

FIG. 7 is an explanatory diagram of a method of determining whether or not a target position is included in a displayed image.

FIG. 8 is a flowchart illustrating processing of the information processing system.

FIG. 9 is a diagram illustrating a display example of an image indicating an imaging direction of the second image.

FIG. 10 is an explanatory diagram of a method of displaying an image indicating the imaging direction of the second image.

FIG. 11 is an explanatory diagram of a method of displaying an image indicating the imaging direction of the second image.

FIG. 12 is a flowchart illustrating a modification of processing of the information processing system.

### DETAILED DESCRIPTION

### Background of Present Disclosure

A user interface is being developed to display a plurality of imaging point icons, which indicate a plurality of imaging points where a construction site is actually imaged on a two-dimensional design drawing of a construction site or the like, and display an image captured at an imaging point indicated by one imaging point icon when one imaging point icon is selected. Thus, the administrator of the construction site can know the situation of the construction site without visiting the construction site.

In addition, for such a user interface, consideration is also given to a function for confirming the presence or absence of a second image captured in the vicinity of the first imaging point on a date and time different from those of the first image, in a state of maintaining the display of the first image captured at the first imaging point indicated by the selected first imaging point icon. Further, it is also considered to facilitate an operation of displaying the second image when the second image is present. Thus, the supervisor can easily check the progress of construction.

In Patent Literature 1, when the presence or absence of the second image is confirmed in a state of maintaining the display of the first image, it is also necessary to perform processing of displaying a screen for inputting an instruction to confirm the presence or absence of the second image, processing of receiving the instruction and confirming the presence or absence of the second image, and the like. This increases the processing steps of the computer and increases the burden on the computer.

Therefore, the present inventors have intensively studied a technology capable of confirming the presence or absence of an image related to the periphery of the imaging point of the image being displayed, which is different from images captured at the plurality of imaging points, in a state of maintaining the display of the image captured at each of the plurality of imaging points without increasing the processing steps, and have arrived at the present disclosure described below.
(1) An information processing method according to one aspect of the present disclosure is an information processing method in a computer, including: displaying, on a display of a terminal device, a bird's-eye view image on which a plurality of imaging point icons indicating a plurality of imaging points is overlaid; and displaying, on the display, a first image captured at a first imaging point indicated by a first imaging point icon when selection of the first imaging point icon that is one imaging point icon among the plurality of imaging point icons is detected, in which the displaying the first image includes displaying information indicating a second image different from a plurality of images captured at the plurality of imaging points on the first image when the second image is associated with a position within a predetermined range with respect to the first imaging point.
According to this configuration, when selection of the first imaging point icon is detected, the first image captured at the first imaging point is displayed on the display, and when the second image is associated with a position within the predetermined range with respect to the first imaging point, information indicating the second image is displayed on the first image. Thus, it is possible to confirm the presence or absence of an image related to the periphery of the imaging point of the image being displayed, which is different from the images captured at the plurality of imaging points, in a state where the display of the image captured at each of the plurality of imaging points is maintained without increasing the processing steps.
(2) In the information processing method according to (1), the second image may be an image captured at a date and time different from a date and time of the plurality of images.
In this case, it is possible to confirm the presence or absence of an image captured at a date and time different from those of the plurality of images, which is related to the periphery of the imaging point of the first image being displayed, without increasing the processing steps.
(3) In the information processing method according to (1) or (2), the information indicating the second image may include an icon indicating the second image.
In this case, when there is the second image related to the periphery of the first imaging point, the icon indicating the second image is displayed while the display of the first image is maintained. Accordingly, the user who has selected the first imaging point icon can intuitively grasp that the second image related to the position near the first imaging point is present while browsing the first image.
(4) In the information processing method according to any one of (1) to (3), the first image may be configured as an omnidirectional image, and the displaying the information indicating the second image may include displaying information indicating the second image on a side closer to a target position that is a position associated with the second image than a center of a displayed image, the displayed image being an image of the first image and being displayed on the display, when the target position is not included in the displayed image.
In this case, since the information indicating the second image is displayed on the side closer to the target position than the center in the displayed image, the relative position of the position associated with the second image with respect to the displayed image can be easily grasped.
(5) In the information processing method according to any one of (1) to (3), the first image may be configured as an omnidirectional image, and the displaying the information indicating the second image may include displaying information indicating the second image at a target position that is a position associated with the second image in a displayed image, the displayed image being an image of the first image and being displayed on the display, when the target position is included in the displayed image.
In this case, since the information indicating the second image is displayed at the target position included in the displayed image, the position associated with the second image can be easily grasped.
(6) In the information processing method according to (5), the information indicating the second image may include an image indicating an imaging direction of the second image.
In this case, the information indicating the second image displayed at the target position in the displayed image includes an image indicating the imaging direction of the second image. Therefore, not only the position with which the second image is associated but also the imaging direction of the second image at the position can be easily grasped.
(7) In the information processing method according to any one of (4) to (6), the displaying the information indicating the second image may include specifying a position of a pixel of the second image in the first image by pattern matching, and specifying the position of the pixel as the target position.
In this case, the position of the pixel of the second image in the first image can be appropriately grasped. Therefore, in particular, when the first image is configured as an omnidirectional image, it is possible to appropriately grasp the positional relationship in the elevation angle direction between the first image and the second image.
(8) The information processing method according to any one of (1) to (7) may further include displaying the second image on the display instead of the first image when selection of the information indicating the second image is detected.
In this case, when the information indicating the second image is displayed on the first screen, the user can immediately confirm the content of the second image by selecting the information indicating the second image.
(9) In the information processing method according to any one of (1) to (8), the information indicating the second image may be different depending on whether the second image is configured as an omnidirectional image or a two-dimensional image.
In this case, when there is a second image related to the periphery of the first imaging point, it is possible to further determine whether the second image is configured as an omnidirectional image or a two-dimensional image.
(10) The information processing method according to any one of (1) to (9) may further include displaying information indicating an image captured at a second imaging point different from the first imaging point among the plurality of imaging points in a mode different from information indicating the second image when an image displayed on the display includes the second imaging point.
In this case, when the second imaging point different from the first imaging point is displayed on the display, the information indicating the image captured at the second imaging point is displayed in a mode different from the information indicating the second image. Therefore, it is possible to further confirm that there is an image captured at the second imaging point around the first imaging point.
(11) In the information processing method according to any one of (1) to (10), the displaying the bird's-eye view image may include further overlaying a position icon indicating a position which the second image is associated with on the bird's-eye view image when the second image is associated with a position within a predetermined range with respect to any imaging point of the plurality of imaging points, and the method may further include displaying the second image associated with the position indicated by the position icon on the display when selection of the position icon is detected.
In this case, depending on whether or not the position icon is overlaid on the bird's-eye view image, it is possible to easily grasp whether or not the second image is associated with the periphery of any one of the plurality of imaging points indicated by the plurality of imaging point icons overlaid on the bird's-eye view image. Further, by selecting the position icon overlaid on the bird's-eye view image, it is possible to grasp details of the second image associated with the position indicated by the position icon.

Further, the present disclosure can be implemented not only as the information processing method for executing the characteristic processing as described above, but also as an information processing device or the like having a characteristic configuration corresponding to characteristic processing executed by the information processing method. Further, the present disclosure can also be implemented as a computer program that causes a computer to execute characteristic processing included in the information processing method described above. Thus, even other aspects below can achieve an effect as in the above information processing method.
(12) An information processing device according to another aspect of the present disclosure includes a processor that executes displaying, on a display of a terminal device, a bird's-eye view image on which a plurality of imaging point icons indicating a plurality of imaging points is overlaid, and displaying, on the display, a first image captured at a first imaging point indicated by a first imaging point icon when selection of the first imaging point icon that is one imaging point icon among the plurality of imaging point icons is detected, in which the displaying the first image includes displaying information indicating a second image different from a plurality of images captured at the plurality of imaging points on the first image when the second image is associated with a position within a predetermined range with respect to the first imaging point.
(13) A non-transitory computer readable storage medium according to still another aspect of the present disclosure is a non-transitory computer readable storage medium storing an information processing program that causes a computer to execute displaying, on a display of a terminal device, a bird's-eye view image on which a plurality of imaging point icons indicating a plurality of imaging points is overlaid, and displaying, on the display, a first image captured at a first imaging point indicated by a first imaging point icon when selection of the first imaging point icon that is one imaging point icon among the plurality of imaging point icons is detected, in which the displaying the first image includes displaying information indicating a second image different from a plurality of images captured at the plurality of imaging points on the first image when the second image is associated with a position within a predetermined range with respect to the first imaging point.

The present disclosure can be also implemented as an information processing system that is operated by such an information processing program. Further, it is needless to say that such a computer program can be distributed via a computer-readable non-transitory recording medium such as a CD-ROM or via a communication network such as the Internet.

Hereinafter, embodiments of the present disclosure will be described with reference to the accompanying drawings. Note that each of the embodiments described below illustrates a specific example of the present disclosure. Numerical values, shapes, constituent elements, steps, order of the steps, and the like of the following embodiments are merely examples, and do not intend to limit the present disclosure. Further, a constituent element not described in an independent claim representing a highest concept among constituent elements in the embodiments below is described as an optional constituent element. Further, in all the embodiments, content of each of the embodiments can be combined.

### Embodiment

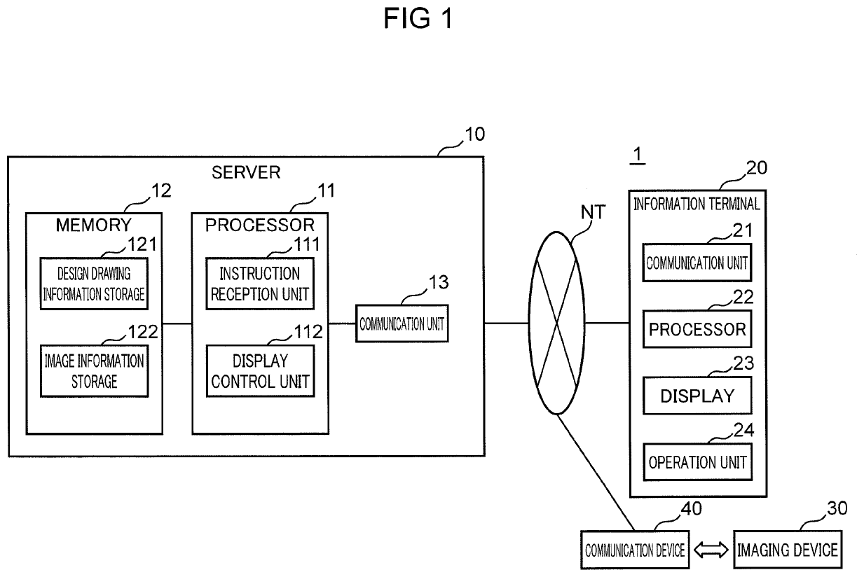

FIG. 1 is an overall configuration diagram of an information processing system 1. The information processing system 1 is a system that displays an image selected from among a plurality of images captured at a series of a plurality of imaging points, and enables confirmation of the presence or absence of an image associated with the vicinity of the imaging point of the image being displayed.

As illustrated in FIG. 1, the information processing system 1 includes a server 10, an information terminal 20 (an example of a terminal device), an imaging device 30, and a communication device 40. The server 10 (an example of an information processing device and a computer), the information terminal 20, and the communication device 40 are communicably connected to each other via a network NT. An example of the network NT is the Internet.

The server 10 is, for example, a cloud server including one or more computers. However, this is an example, and the server 10 may be configured by an edge server or may be implemented in the information terminal 20. An aspect in which the server 10 is implemented in the information terminal 20 is an example of an aspect in which the information terminal 20 is configured by an information processing device.

The information terminal 20 is carried by a user. The user is, for example, an administrator of a predetermined space imaged by the imaging device 30. The predetermined space is, for example, a construction site. However, this is an example, and the predetermined space may be a construction site, a factory, a store, an office, or the like. The information terminal 20 may be configured by, for example, a portable computer such as a smartphone or a tablet computer, or may be configured by a stationary computer. The information terminal 20 displays various images and screens on the display in accordance with a display instruction from the server 10. Although one information terminal 20 is illustrated in the example of FIG. 1, a plurality of information terminals may be connected to the server 10 via the network NT. The information terminal 20 includes a communication unit 21, a processor 22, a display 23, and an operation unit 24.

The communication unit 21 is a communication interface that connects the information terminal 20 to the network NT. The communication unit 21 transmits various instructions received from the user by the operation unit 24 to the server 10. The communication unit 21 receives display instructions for various images and screens from the server 10.

The processor 22 is configured by, for example, a central processing unit, and causes various images and screens to be displayed on the display 23 in accordance with display instructions for various images and screens received by the communication unit 21.

The display 23 is configured by various display devices such as a liquid crystal display and an organic electro-luminescence (EL) display, and displays various images and screens under the control of the processor 22.

The operation unit 24 is configured by a keyboard, a touch panel, a mouse, and the like, and receives various instructions input by the user.

The communication device 40 is configured by, for example, a portable information terminal such as a smartphone or a tablet computer, and connects the imaging device 30 to the network NT. The communication device 40 and the imaging device 30 are connected via a proximity wireless communication path such as Bluetooth (registered trademark).

The imaging device 30 is configured by, for example, an omnidirectional camera, and captures an image at a predetermined frame rate. The omnidirectional camera is also referred to as a 360-degree camera, and is a camera capable of acquiring an omnidirectional image of 360 degrees. The imaging device 30 is, for example, a portable imaging device carried by an operator. The operator is, for example, a worker or a site supervisor at a construction site. Note that the imaging device 30 may be configured by a normal camera.

The operator moves in the construction site while imaging the construction site with the imaging device 30. At the imaging start position, the operator presses the imaging button of the imaging device 30 while directing the imaging device 30 toward a direction (hereinafter, a reference direction) with respect to the imaging direction of the imaging device 30. Thus, the imaging device 30 starts capturing an image at a predetermined frame rate. Accordingly, the imaging point is defined in units of frame periods. However, in this case, since the data amount becomes enormous, the imaging point may be defined every predetermined time (for example, one second, five seconds, ten seconds, one minute, or the like). When reaching the imaging end point, the operator presses the imaging button again. Thus, the imaging device 30 ends the imaging. When imaging is completed, the imaging device 30 transmits a series of captured images to the communication device 40. In the following description, the reference direction is the north direction. However, the reference direction is not limited to the north direction, and may be another direction.

In addition, there is a case where the operator individually images the surroundings of a specific imaging point by the imaging device 30 in order to confirm the progress status of work at a series of imaging points where images were captured in the past. In this case, the image captured by the imaging device 30 may be a two-dimensional image or an omnidirectional image of 360 degrees. In this case, when the imaging is completed, the imaging device 30 transmits the captured image and the imaging direction of the image to the communication device 40. Note that when the captured image is a two-dimensional image, the imaging direction of the image is represented by, for example, a two-dimensional polar coordinate vector with the north direction as a reference direction. When the captured image is an omnidirectional image, the imaging direction of the image is represented by, for example, a three-dimensional polar coordinate vector with the north direction as a reference direction.

The communication device 40 receives a series of images transmitted by the imaging device 30. In this case, the communication device 40 causes the design drawing of the construction site to be displayed, and receives designation by the operator of the position of the imaging start point and the position of the imaging end point on the design drawing. The imaging start point and the imaging end point are specified by the operator inputting an instruction to designate the position on a design drawing screen of the site displayed on the display of the communication device 40. Two-dimensional coordinate axes are defined on the design drawing screen. In the two-dimensional coordinate axes, for example, the east-west direction in the design drawing is defined as a horizontal axis or an X axis, and the north-south direction is defined as a vertical axis or a Y axis. Therefore, the imaging start point and the imaging end point are each defined by two-dimensional coordinate values. The communication device 40 transmits imaging information including a series of captured images to the server 10 via the network NT.

The imaging information is generated every time one imaging operation is performed. One imaging operation refers to a series of operations from the start of imaging to the end at the construction site by a worker with the imaging device 30. A plurality of images is captured by one imaging operation. The imaging information includes a plurality of captured images and meta information of each of the plurality of images. The meta information includes an imaging ID, an imaging date and time, a design drawing ID, an imaging start point, and an imaging end point.

The imaging ID is an identifier for identifying an imaging operation. The imaging date and time is the imaging date and time of the image. The imaging date and time is acquired by, for example, a clock included in the imaging device 30. The design drawing ID is an identifier for identifying a design drawing of a predetermined space corresponding to an image. The imaging start point and the imaging end point are used to specify an imaging point and an imaging direction of each image.

Further, the communication device 40 receives an image obtained by imaging the surroundings of a specific imaging point transmitted by the imaging device 30. In this case, the communication device 40 causes the design drawing of the construction site to be displayed similarly to the case of designating the imaging start point and the imaging end point, and receives designation by the operator of the imaging point of the received image on the design drawing. The communication device 40 transmits imaging information including the received image to the server 10 via the network NT. In this case, the imaging information includes the image received from the imaging device 30 and the meta information of the image. The meta information of the image includes an imaging ID, an imaging date and time, a design drawing ID, an imaging point, and an imaging direction.

The server 10 includes a processor 11, a memory 12, and a communication unit 13. The processor 11 is configured by, for example, a central processing unit (CPU). The processor 11 includes an instruction reception unit 111 and a display control unit 112. The instruction reception unit 111 and the display control unit 112 may be implemented by the processor 11 executing the information processing program, or may be configured by a dedicated hardware circuit such as an ASIC. The information processing program may be recorded in a non-transitory computer-readable recording medium.

The communication unit 13 is a communication interface that connects the server 10 to the network NT. The communication unit 13 receives the imaging information transmitted by the communication device 40. The communication unit 13 receives various instructions from the user from the information terminal 20. The communication unit 13 transmits display instructions for various images and screens to the information terminal 20.

The memory 12 is configured by a nonvolatile rewritable storage device such as a hard disk drive or a solid state drive. The memory 12 includes a design drawing information storage 121 and an image information storage 122.

The design drawing information storage 121 stores design drawing information. The design drawing information is information in which a design drawing ID and a design drawing of a predetermined space identified by the design drawing ID are associated with each other. The design drawing is a drawing illustrating a design of a construction site, and may be a plan view, a blueprint, a map, a perspective view, or the like of the construction site. The design drawing is an example of a bird's-eye view image. The bird's-eye view image can also be referred to as an overhead view image, and may be an image viewed from above or an image viewed from a high position.

The image information storage 122 stores image information. The image information is information in which an image and meta information of the image are associated with each other. The meta information includes an imaging ID, an imaging date and time, a design drawing ID, an imaging point, and an imaging direction. Specifically, the processor 11 creates image information on the basis of the imaging information received by the communication unit 13, and stores the created image information in the image information storage 122.

More specifically, when the meta information included in the imaging information received by the communication unit 13 includes the imaging point and the imaging direction, the processor 11 creates image information in which the image included in the imaging information is associated with the meta information included in the imaging information, and stores the created image information in the image information storage 122.

On the other hand, when the imaging start point and the imaging end point are included in the meta information included in the imaging information received by the communication unit 13, the processor 11 specifies the imaging point of each image from the imaging start point, the imaging end point, and the plurality of images included in the imaging information by using a visual simultaneous localization and mapping (SLAM) technology. The imaging point of each image is represented by two-dimensional coordinate values on the design drawing. Further, the processor 11 also specifies the imaging direction of each image using the visual SLAM technology. The imaging direction of each image is represented by, for example, a three-dimensional polar coordinate vector with the north direction as a reference direction.

The processor 11 adds the specified imaging point and imaging direction of each image to the meta information of each image included in the imaging information. The processor 11 creates image information in which the meta information and each image included in the imaging information are associated with each other, and stores the created image information in the image information storage 122. Note that, instead of calculating the imaging point and the imaging direction of each image in the processor 11, the communication device 40 may calculate the imaging point and the imaging direction of each image, and include the calculated imaging point and imaging direction of each image in the meta information of each image to be transmitted to the server 10.

The instruction reception unit 111 acquires an instruction by the user input to the information terminal 20. Specifically, when the communication unit 13 receives an instruction from the user from the information terminal 20, the instruction reception unit 111 detects an input of the instruction. The instruction includes, for example, a selection instruction for a design drawing, a designation instruction for imaging date and time, a selection instruction for an imaging point icon, a change instruction for a display angle of view, and the like.

The selection instruction for a design drawing is an instruction to select, as a design drawing of a processing target, a design drawing corresponding to a design ID input by the user. The designation instruction for an imaging date and time is an instruction to designate, as an imaging date and time of a processing target, an imaging date and time input by the user. The imaging point icon is an icon overlay-displayed at the position of the imaging point included in the design drawing. The selection instruction for an imaging point icon is an instruction to select, as an imaging point icon of a processing target, an imaging point icon selected by the user from among the plurality of imaging point icons overlay-displayed on the design drawing. The change instruction for a display angle of view is an instruction to change an angle of view of an image (hereinafter, a displayed image) displayed on the display 23 of the information terminal 20.

When the instruction reception unit 111 detects the input of the selection instruction for a design drawing, the display control unit 112 reads the design drawing selected by the selection instruction from the design drawing information storage 121. The display control unit 112 causes the read design drawing to be displayed on the display 23 of the information terminal 20. When the instruction reception unit 111 detects the input of the designation instruction for an imaging date and time, the display control unit 112 causes a plurality of imaging point icons indicating a plurality of imaging points at the imaging date and time designated by the instruction to be overlaid on the design drawing. In addition, the display control unit 112 causes a line indicating a locus along which the operator has moved during imaging and connecting the imaging point icons adjacent to each other to be overlaid on the design drawing.

Further, in some cases, an image (hereinafter, a second image) different from a plurality of images captured at a plurality of imaging points indicated by the plurality of imaging point icons is associated with a position within a predetermined range with respect to any one of the plurality of imaging points. The position within a predetermined range with respect to the imaging point is a position within a certain distance range around the imaging point.

The second image is, for example, an image stored in the image information storage 122 and captured at a date and time different from those of a plurality of images captured at the plurality of imaging points indicated by the plurality of imaging point icons. The second image is not limited thereto, and may be an image stored in the image information storage 122 and captured at an imaging point different from the plurality of imaging points on the same date and time as that of the plurality of images captured at the plurality of imaging points indicated by the plurality of imaging point icons. The second image associated with the position within the predetermined range with respect to the imaging point is a second image associated with the position as an imaging point in the image information stored in the image information storage 122.

As described above, when the second image is associated with a position within a predetermined range with respect to any one of the plurality of imaging points indicated by the plurality of imaging point icons, the display control unit 112 further causes a position icon indicating the position associated with the second image to be overlaid on the design drawing.

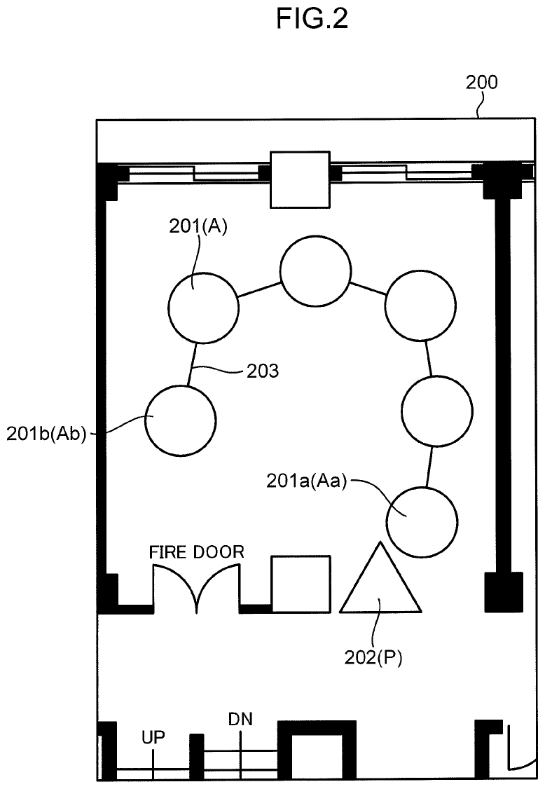

FIG. 2 is a diagram illustrating an example of a design drawing 200 displayed on the display 23 of the information terminal 20. FIG. 2 illustrates an example in which six imaging point icons 201, one position icon 202, and a locus 203 are overlay-displayed on the design drawing 200. In this example, the imaging point icons 201 are each formed by a circular image. This indicates that a series of a plurality of images captured at the six imaging points A indicated by the six imaging point icons 201 are omnidirectional images.

On the other hand, the position icon 202 is formed by a triangular image. This indicates that the second image associated with the position P indicated by the position icon 202 within the predetermined range with respect to an imaging point Aa indicated by an imaging point icon 201a is a two-dimensional image (planar image). When the second image associated with the position P indicated by the position icon 202 is an omnidirectional image (360-degree image), the display control unit 112 causes the position icon 202 of a mode (for example, a rhombus) different from the imaging point icon 201 to be displayed.

The locus 203 is formed by a line connecting the adjacent imaging point icons 201. In this example, the locus 203 indicates the locus of the operator who has captured the images at the six imaging points A indicated by the six imaging point icons 201. The imaging point icon 201a located at the leading end of the locus 203 indicates the imaging start point Aa, and the imaging point icon 201b located at the trailing end of the locus 203 indicates the imaging end point Ab.

Therefore, the user viewing the design drawing 200 of the example of FIG. 2 can easily grasp that there are the imaging point A and the type (omnidirectional image) of the six images captured in one imaging operation in the predetermined space indicated by the design drawing 200 and the second image of a two-dimensional image individually captured at the position P within the predetermined range with respect to the imaging start point Aa.

Here, it is assumed that when the user selects the imaging point icon 201 indicating one imaging point A from among the plurality of imaging point icons 201 displayed on the display 23 of the information terminal 20, the instruction reception unit 111 detects the input of the selection instruction for the imaging point A. Hereinafter, the imaging point icon 201 indicating the one imaging point A selected by the user is referred to as a first imaging point icon 201a. The imaging point A indicated by the first imaging point icon 201a is referred to as a first imaging point Aa.

In this case, the display control unit 112 reads the image captured at the first imaging point Aa from the image information storage 122, and causes the read image to be displayed on the display 23 of the information terminal 20. Hereinafter, the image captured at the first imaging point Aa is referred to as a first image. When the second image is associated with a position within the predetermined range with respect to the first imaging point Aa, the display control unit 112 causes information indicating the second image to be displayed on the first image.

Specifically, when the image of the first image, the image being displayed on the display 23 (hereinafter, the displayed image), does not include the position (hereinafter, target position) associated with the second image, the display control unit 112 causes information indicating the second image to be displayed on the side closer to a target position than the center of the displayed image. On the other hand, when the target position is included in the displayed image, the display control unit 112 causes information indicating the second image to be displayed at the target position in the displayed image.

In other words, when the imaging point of the second image is not included in the angle of view of the displayed image, the display control unit 112 causes the information indicating the second image to be displayed on the side closer to the position corresponding to the imaging point of the second image than the center of the displayed image. On the other hand, when the imaging point of the second image is included in the angle of view of the displayed image displayed on the display 23, the display control unit 112 causes information indicating the second image to be displayed at a position corresponding to the imaging point of the second image in the displayed image.

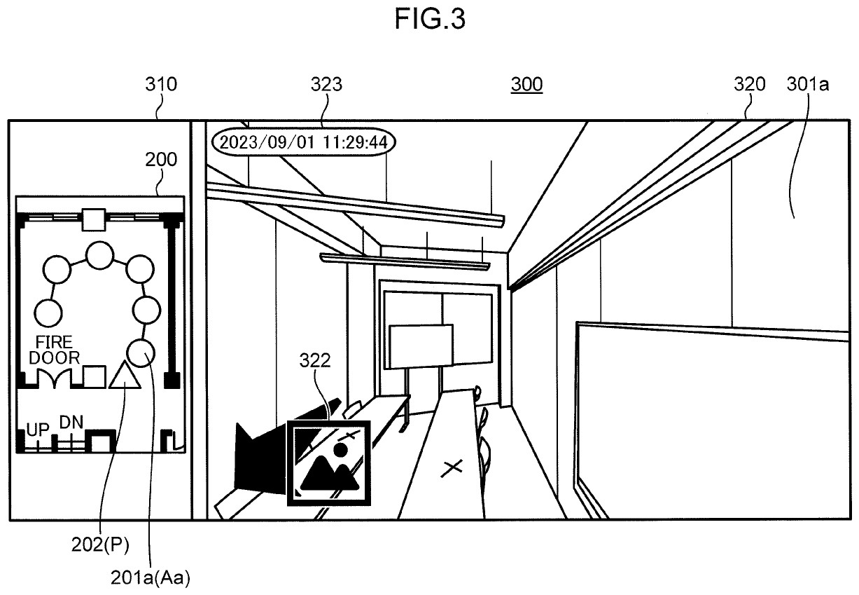

FIG. 3 is a diagram illustrating an example of a display screen 300 to be displayed on the display 23 when the first imaging point icon 201a is selected. The display screen 300 includes a design drawing display field 310 and a detailed image display field 320. When the instruction reception unit 111 detects the input of the selection instruction of the first imaging point Aa, the display control unit 112 causes the design drawing 200 in which the imaging point icon 201 and the like are overlay-displayed to be continuously displayed in the design drawing display field 310 of the display screen 300, and causes an image 301a having a predetermined angle of view extracted from the first image to be displayed in the detailed image display field 320.

The display control unit 112 further causes an imaging date and time 323 of the first image to be overlay-displayed on the upper left corner of the detailed image display field 320. Note that the display position of the imaging date and time 323 of the first image is not limited to the upper left corner of the detailed image display field 320, and may be, for example, the upper right corner of the detailed image display field 320. In addition, the display control unit 112 may cause the imaging date and time 323 of the first image not to be displayed in the detailed image display field 320.

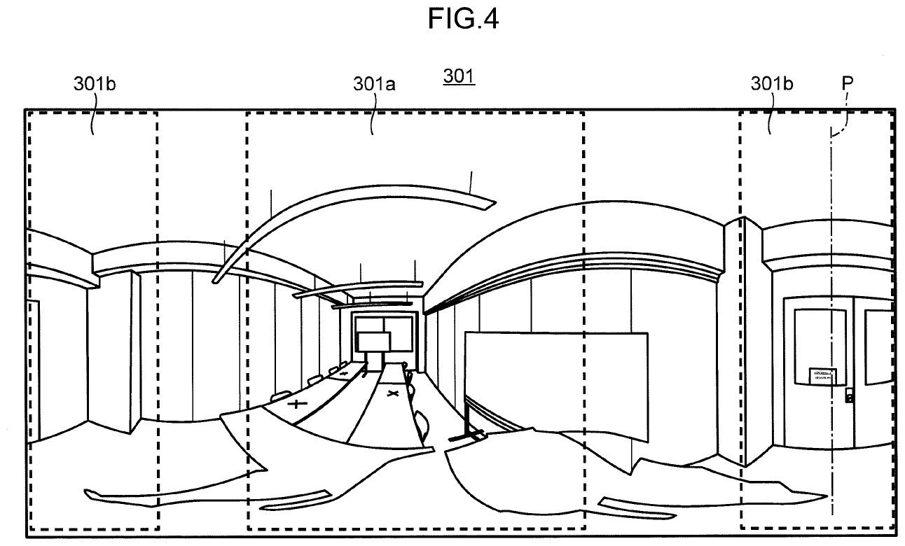

FIG. 4 is a diagram illustrating an example of a first image 301. Specifically, when the first image 301 is an omnidirectional image as illustrated in FIG. 4, the display control unit 112 extracts the image 301a having a predetermined angle of view that can be displayed in the detailed image display field 320 from the first image 301, and causes the extracted image 301a to be displayed in the detailed image display field 320 as illustrated in FIG. 3.

In FIG. 4, a reference sign P indicates a position (target position) associated with the second image. FIG. 3 illustrates an example in which the target position P, which is the imaging point of the second image, is not included in the angle of view of the displayed image 301a of the first image 301, displayed on the display 23, and thus the display control unit 112 causes an icon 322 indicating the second image to be displayed as the information indicating the second image on the left side closer to the target position P than the center of the displayed image 301a. Note that details of the processing in which the display control unit 112 determines whether or not the target position P is included in the displayed image 301a will be described later.

In the first image 301, when the distance from the center of the displayed image 301a to the target position P in the left direction is shorter than the distance from the center of the displayed image 301a to the target position P in the right direction, the display control unit 112 causes the icon 322 indicating the second image to be displayed on the left side closer to the target position P than the center of the displayed image 301a.

On the other hand, in the first image 301, when the distance from the center of the displayed image 301a to the target position P in the right direction is shorter than the distance from the center of the displayed image 301a to the target position P in the left direction, the display control unit 112 causes the icon 322 indicating the second image to be displayed on the right side closer to the target position P than the center of the displayed image 301a. In this case, the icon 322 displayed on the right side closer to the target position P than the center of the displayed image 301a may be an icon obtained by horizontally inverting the icon 322 illustrated in FIG. 3. In addition, the mode of the icon 322 indicating the second image may be different depending on whether the second image is configured as an omnidirectional image or a two-dimensional image.

Here, it is assumed that an operation of sliding, in a certain direction, the displayed image 301a displayed in the detailed image display field 320 is performed. In this case, the information terminal 20 transmits, to the server 10, the change instruction for a display angle of view indicating that the angle of view of the image 301a displayed in the detailed image display field 320 is changed by the sliding amount in the direction. When the instruction reception unit 111 detects the input of the change instruction, the display control unit 112 changes the angle of view of the image 301a displayed in the detailed image display field 320 in the direction opposite to the direction indicated by the change instruction by the amount indicated by the change instruction.

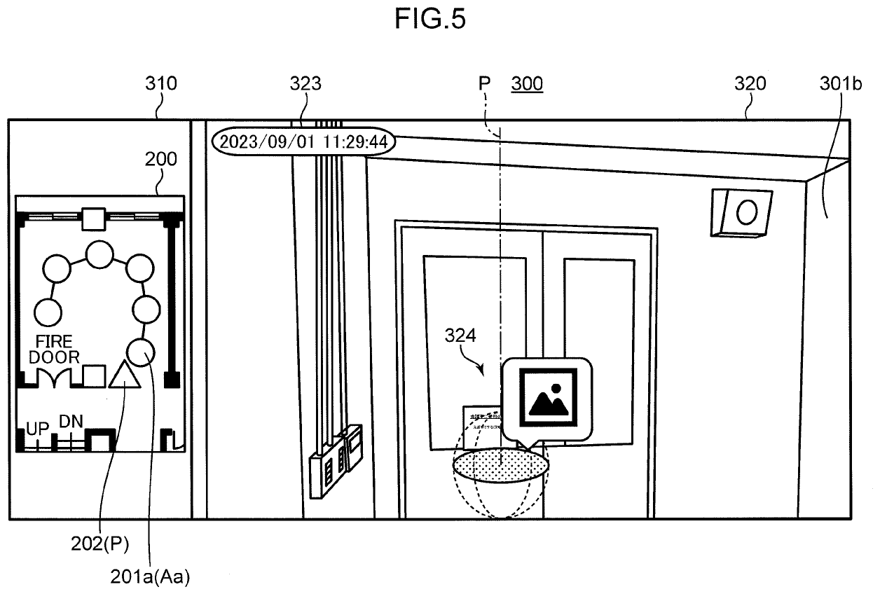

FIG. 5 is a diagram illustrating another example of the display screen 300 to be displayed on the display 23 when the first imaging point icon 201a is selected. For example, as illustrated in FIG. 3, it is assumed that a part of the image 301a near the center of the first image 301 is displayed in the detailed image display field 320. In this case, when the operation of sliding the image 301a in the left direction is performed, the display control unit 112 extracts an image 301b (FIG. 4) changed by the amount indicated by the change instruction in the right direction opposite to the direction indicated by the change instruction detected by the instruction reception unit 111 from the first image 301 illustrated in FIG. 4, and causes the image 301b to be displayed in the detailed image display field 320 as illustrated in FIG. 5.

FIG. 5 illustrates an example in which the display control unit 112 causes an icon 324 indicating the second image to be displayed at the target position P in the displayed image 301b because the target position P, which is the imaging point of the second image, is included in the angle of view of the displayed image 301b of the first image 301, displayed on the display 23. Note that the mode of the icon 324 indicating the second image may be different depending on whether the second image is configured as an omnidirectional image or a two-dimensional image, similarly to the icon 322 indicating the second image.

When an operation of selecting the icon 324 indicating the second image is performed, the information terminal 20 transmits a display instruction for the second image indicated by the icon 324 to the server 10. Further, also when an operation of selecting the position icon 202 overlay-displayed on the design drawing 200 displayed in the design drawing display field 310 is performed, the information terminal 20 similarly transmits, to the server 10, a display instruction for the second image associated with the position P indicated by the position icon 202.

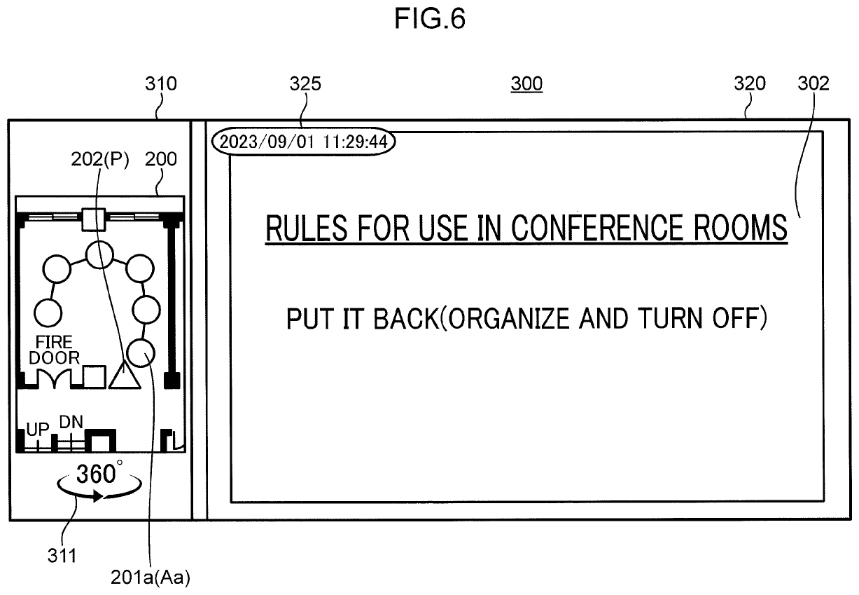

FIG. 6 is a diagram illustrating an example of a display screen 300 on which a second image 302 is displayed. When the instruction reception unit 111 detects the input of the display instruction for the second image 302, the display control unit 112 causes the second image 302 indicated by the display instruction to be displayed in the detailed image display field 320 instead of the first image 301 as illustrated in FIG. 6.

The display control unit 112 further causes an imaging date and time 325 of the second image 302 displayed in the detailed image display field 320 to be overlay-displayed on the upper left corner of the detailed image display field 320. Note that the display position of the imaging date and time 325 is not limited to the upper left corner of the detailed image display field 320, and may be, for example, the upper right corner of the detailed image display field 320. In addition, the display control unit 112 may cause the imaging date and time 325 of the second image 302 not to be displayed in the detailed image display field 320.

The display control unit 112 further causes a redisplay icon 311 to be displayed at the lower end of the design drawing display field 310 for redisplaying, in the detailed image display field 320, the first image 301 that has been displayed in the detailed image display field 320 immediately before the second image 302 is displayed. The display position of the redisplay icon 311 is not limited to the lower end of the design drawing display field 310, and may be, for example, a region where the design drawing 200 is not displayed in the design drawing display field 310, such as the upper end of the design drawing display field 310.

When an operation of selecting the redisplay icon 311 is performed, the information terminal 20 transmits a redisplay instruction for the first image 301 to the server 10. When the instruction reception unit 111 detects the input of the redisplay instruction, the display control unit 112 causes the first image 301 that has been displayed in the detailed image display field 320 immediately before the second image 302 is displayed, to be displayed in the detailed image display field 320 instead of the second image 302 as illustrated in FIG. 5.

In the above example, the mode of the icon 322 (FIG. 3) indicating the second image displayed in the displayed image 301a not including the target position P is different from the mode of the icon 324 (FIG. 5) indicating the second image 302 displayed in the displayed image 301b including the target position P. However, the modes of the two icons 322 and 324 may be the same.

The processing described above in which the display control unit 112 causes an image or the like to be displayed on the display 23 of the information terminal 20 is implemented by the display control unit 112 transmitting a display instruction including image data of an image, a display screen, and the like to be displayed on the display 23 to the information terminal 20 using the communication unit 13.

### (Method for Determining Whether or not Target Position P is Included in Displayed Image)

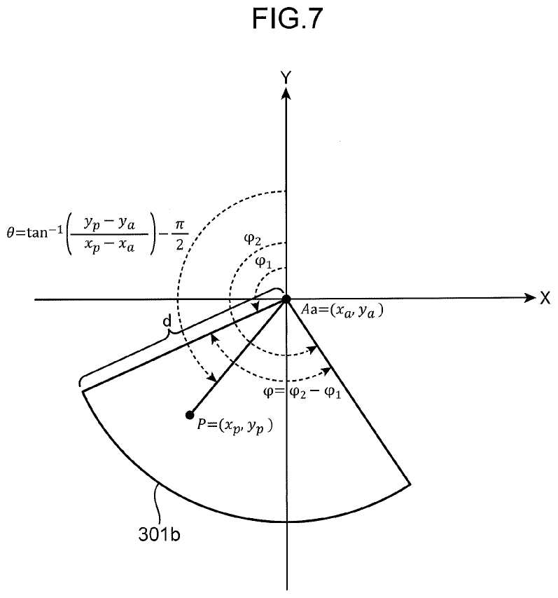

Next, details of the processing of determining whether or not the target position P is included in the displayed image performed by the display control unit 112 will be described. FIG. 7 is an explanatory diagram of a method of determining whether or not the target position P is included in the displayed image. An X axis in FIG. 7 indicates an east-west direction which is a horizontal axis of the design drawing 200, a direction of +X indicates an east direction, and a direction of −X indicates a west direction. The Y axis indicates a north-south direction which is a vertical axis of the design drawing 200, a +Y (upward) direction indicates a north direction, and a −Y (downward) direction indicates a south direction.

The coordinates (xₐ, yₐ) in FIG. 7 indicate the coordinates of the imaging point A of the first image 301, which is the displayed image displayed in the detailed image display field 320, that is, the first imaging point Aa indicated by the first imaging point icon 201a selected in the design drawing 200. The coordinates (xₚ, yₚ) in FIG. 7 indicate the imaging point of the second image 302 located at a position shorter than a predetermined distance d from the first imaging point Aa, that is, the coordinates of target position P.

Here, it is assumed that the image 301b having a predetermined angle of view φ (=φ₂−φ₁) from a direction (hereinafter, a first direction) rotated counterclockwise by an angle φ₁ from the north direction (+Y (upward) direction), which is the reference direction of the imaging direction, to a direction (hereinafter, a second direction) rotated counterclockwise by an angle φ₂ from the north direction is displayed in the detailed image display field 320.

Note that when the first image 301 is first displayed in the detailed image display field 320 (FIGS. 3 and 5), the display control unit 112 extracts an image having a predetermined angle of view q from the first image 301 on the assumption that the initial value of the angle φ₁ is −φ/2 and the initial value of the angle φ₂ is φ/2 so that an image obtained by imaging the north direction is displayed, and causes the image to be displayed in the detailed image display field 320. Note that the initial values of the angle φ₁ and the angle φ₂ are not limited thereto, and may be determined in advance to other angles. Thereafter, the display control unit 112 changes the angle of view of the image displayed in the detailed image display field 320 according to the change instruction for a display angle of view detected by the instruction reception unit 111, so that the angle φ₁ and the angle φ₂ can be grasped.

Therefore, if a direction rotated counterclockwise by an angle θ from the north direction, which is a direction from the coordinates (xₐ, yₐ) of the first imaging point Aa toward the coordinates (xₚ, yₚ) of the target position P, is a direction between the first direction and the second direction, the display control unit 112 determines that the target position P is included in the displayed image 301b. On the other hand, when the direction rotated counterclockwise by the angle θ from the north direction is not the direction between the first direction and the second direction, the display control unit 112 determines that the target position P is not included in the displayed image 301b.

More specifically, the display control unit 112 calculates the angle θ using the following equation based on the coordinates (xₐ, yₐ) of the first imaging point Aa and the coordinates (xₚ, yₚ) of the target position P.

$$θ = {tan}^{- 1} ( \frac{{y}_{p} - {y}_{a}}{{x}_{p} - {x}_{a}} ) - \frac{π}{2} \qquad [ Mathematical Formula 1 ]$$

When the calculated angle θ is equal to or larger than the angle φ₁ and equal to or smaller than the angle 2, the display control unit 112 determines that the target position P is included in the image 301b. On the other hand, when the calculated angle θ is less than the angle φ₁ or larger than the angle φ₂, the display control unit 112 determines that the target position P is not included in the image 301b.

Note that the above equation is obtained by deriving a direction from the coordinates (xₐ, yₐ) of the first imaging point Aa toward the coordinates (xₚ, yₚ) of the target position P as a direction rotated counterclockwise by the angle θ from the north direction. However, the above expression may be modified so that the direction from the coordinates (xₐ, yₐ) of the first imaging point Aa toward the coordinates (xₚ, yₚ) of the target position P is expressed using an angle of clockwise rotation or counterclockwise rotation from the direction with reference to a direction different from the north direction in the design drawing 200.

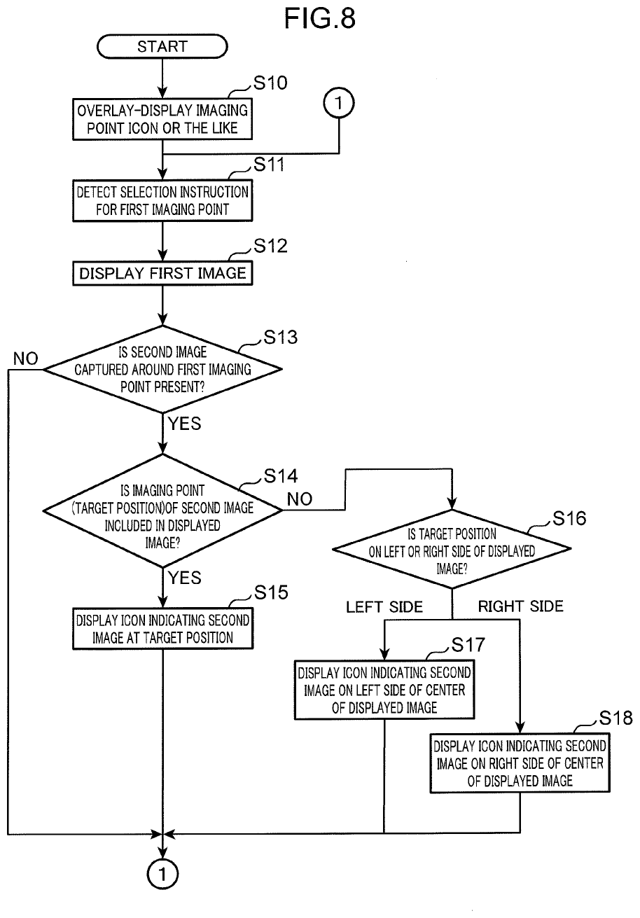

Next, the processing of the information processing system 1 will be described. FIG. 8 is a flowchart illustrating processing of the information processing system 1. The instruction reception unit 111 detects the input of the selection instruction for the design drawing, the display control unit 112 causes the design drawing 200 selected by the selection instruction to be displayed on the display 23 of the information terminal 20, and then the flowchart starts with the detection by the instruction reception unit 111 of an input of a designation instruction for the imaging date and time as a trigger.

In step S10, as illustrated in FIG. 2, the display control unit 112 causes a plurality of imaging point icons 201 indicating a plurality of imaging points A at the imaging date and time designated by the designation instruction detected by the instruction reception unit 111 to be overlaid on the design drawing 200. Further, the display control unit 112 causes the locus 203 along which the operator has moved during imaging to be overlaid on the design drawing 200. Furthermore, when the second image is associated with a position within a predetermined range with respect to any of the plurality of imaging points A indicated by the plurality of imaging point icons 201, the display control unit 112 causes a position icon 202 indicating a position P associated with the second image to be overlaid on the design drawing 200.

Next, in step S11, when the user selects the first imaging point icon 201a indicating the first imaging point Aa, the instruction reception unit 111 detects an input of a selection instruction for the first imaging point Aa.

Next, in step S12, the display control unit 112 reads the first image 301 captured at the first imaging point Aa from the image information storage 122, and extracts the image 301a having the predetermined angle of view q (FIG. 7) from the read first image 301. For example, as illustrated in FIG. 3, the display control unit 112 causes the design drawing 200 to be displayed in which an imaging point icon 201 and the like are overlay-displayed continuously on the design drawing display field 310 of the display screen 300, and causes the extracted image 301a to be displayed in the detailed image display field 320 of the display screen 300.

Next, in step S13, the display control unit 112 determines whether or not the second image 302 is associated with a position within a predetermined range with respect to the first imaging point Aa. When it is determined that the second image 302 is associated (YES in step S13), the processing proceeds to step S14. When it is determined that the second image 302 is not associated (NO in step S13), the processing returns to step S11.

In step S14, the display control unit 112 determines whether or not the position associated with the second image 302, that is, the target position P, which is the imaging point of the second image 302, is included in the displayed image displayed in the detailed image display field 320. When it is determined that the target position P is included in the displayed image (YES in step S14), the processing proceeds to step S15. When it is determined that the target position P is not included in the displayed image (NO in step S14), the processing proceeds to step S16.

In step S15, for example, as illustrated in FIG. 5, the display control unit 112 causes the icon 324 indicating the second image 302 to be displayed at the target position P included in the displayed image. When the processing of step S15 ends, the processing returns to step S11.

In step S16, the display control unit 112 determines whether the target position P is on the left side or the right side with respect to the displayed image displayed in the detailed image display field 320. Specifically, when the distance from the center of the displayed image to the target position P in the left direction is shorter than the distance from the center of the displayed image to the target position P in the right direction, the display control unit 112 determines that the target position P is on the left side with respect to the displayed image. Conversely, when the distance from the center of the displayed image to the target position P in the right direction is shorter than the distance from the center of the displayed image to the target position P in the left direction, the display control unit 112 determines that the target position P is on the right side with respect to the displayed image.

When it is determined in step S16 that the target position P is on the left side with respect to the displayed image (left side in step S16), the processing proceeds to step S17. When it is determined that the target position P is on the right side with respect to the displayed image (right side in step S16), the processing proceeds to step S18.

In step S17, for example, as illustrated in FIG. 4, the display control unit 112 causes the icon 322 indicating the second image to be displayed on the left side closer to the target position P than the center of the displayed image 301a. When the processing of step S17 ends, the processing returns to step S11.

In step S18, the display control unit 112 causes an icon indicating the second image to be displayed on the right side closer to the target position P than the center in the displayed image. When the processing of step S18 ends, the processing returns to step S11.

As described above, according to the above embodiment, when the selection of the first imaging point icon 201a is detected, the first image 301 captured at the first imaging point Aa is displayed on the display 23, and when the second image 302 is associated with a position within the predetermined range with respect to the first imaging point Aa, the icons 322 and 324 indicating the second image 302 are displayed on the first image 301. As a result, it is possible to confirm the presence or absence of the second image 302 related to the periphery of the first imaging point Aa, which is the imaging point of the first image 301 being displayed, without increasing the processing steps.

Modifications described below can be adopted for the present disclosure.
(1) In step S15 (FIG. 8), the display control unit 112 may further include an image indicating the imaging direction of the second image 302 in information indicating the second image 302 displayed at the target position P in the displayed image. In this case, not only the target position P with which the second image 302 is associated but also the imaging direction of the second image 302 at the target position P can be easily grasped.

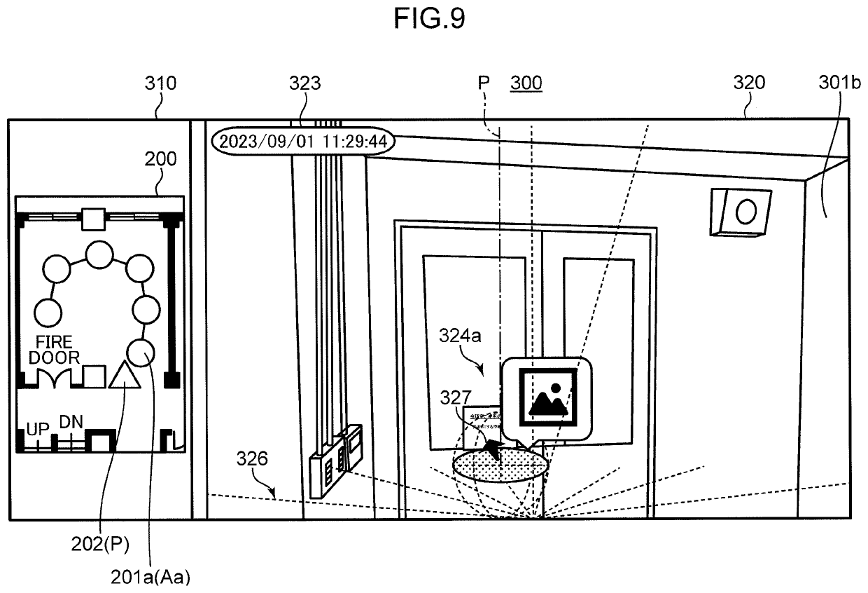

FIG. 9 is a diagram illustrating a display example of an image 327 indicating the imaging direction of the second image 302. Specifically, as illustrated in FIG. 9, when the target position P is included in the displayed image 301b displayed in the detailed image display field 320, the display control unit 112 may display an icon 324a indicating the second image 302 and the image 327 indicating the imaging direction of the second image 302 at the target position P.

Note that FIG. 9 illustrates an example in which the display control unit 112 further causes an auxiliary line 326 for stereoscopically viewing the displayed image 301b displayed in the detailed image display field 320 to be overlaid on the displayed image 301b, but the auxiliary line 326 need not be displayed. In FIG. 9, in order to more clearly grasp the imaging direction of the second image 302, an auxiliary line indicating the east-west direction and the north-south direction is included in the icon 324a indicating the second image 302. However, the same icon as the icon 322 indicating the second image 302 not including the auxiliary line illustrated in FIG. 5 may be adopted as the icon indicating the second image 302. In addition, similarly to the icon 324 indicating the second image, the mode of the icon 324a indicating the second image may be different depending on whether the second image is configured as an omnidirectional image or a two-dimensional image.

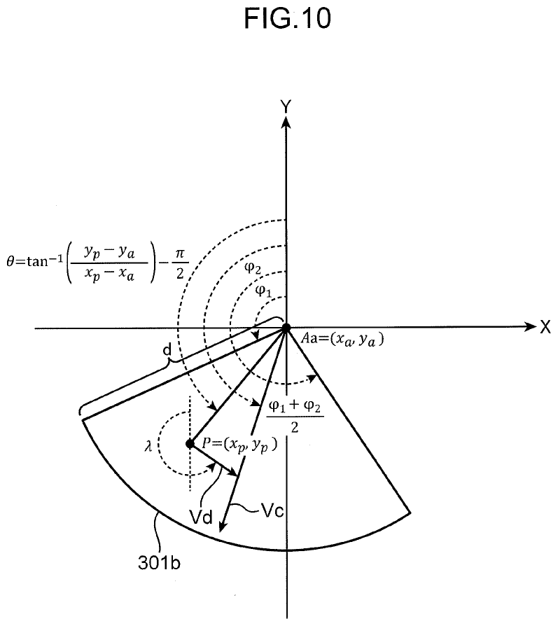

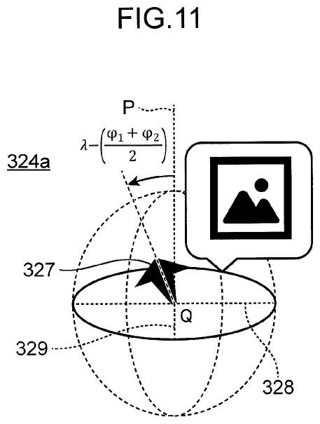

The present modification can be implemented, for example, as follows. FIGS. 10 and 11 are explanatory diagrams of a method of displaying the image 327 indicating the imaging direction of the second image 302. FIG. 10 is a diagram in which vector Vd indicating the imaging direction of the second image 302 and vector Vc indicating the central direction of the angle of view of displayed image 301b are added to FIG. 7.

As illustrated in FIG. 10, the display control unit 112 refers to the meta information of the second image 302 stored in the image information storage 122, and acquires an angle (hereinafter, first angle) λ formed by the imaging direction (vector Vd) of the second image 302 counterclockwise from the north direction. The display control unit 112 calculates an angle (hereinafter, second angle) (φ₁φ₂)/2 formed by the central direction (vector Vc) of the angle of view of the displayed image 301b counterclockwise from the north direction using the angle φ₁ formed by the first direction counterclockwise from the north direction and the angle φ₂ formed by the second direction counterclockwise from the north direction.

Then, as illustrated in FIG. 11, the display control unit 112 causes the icon 324a to be overlaid on the displayed image 301b so that the center Q (the intersection of an auxiliary line 328 indicating the east-west direction and an auxiliary line 329 indicating the north-south direction) of the icon 324a indicating the second image 302 is located on the target position P.

Next, the display control unit 112 calculates the angle λ−(φ₁+φ₂)/2 obtained by subtracting the second angle (φ₁+φ₂)/2 from the first angle λ as an angle (hereinafter, third angle) used for displaying the image 327 indicating the imaging direction of the second image 302.

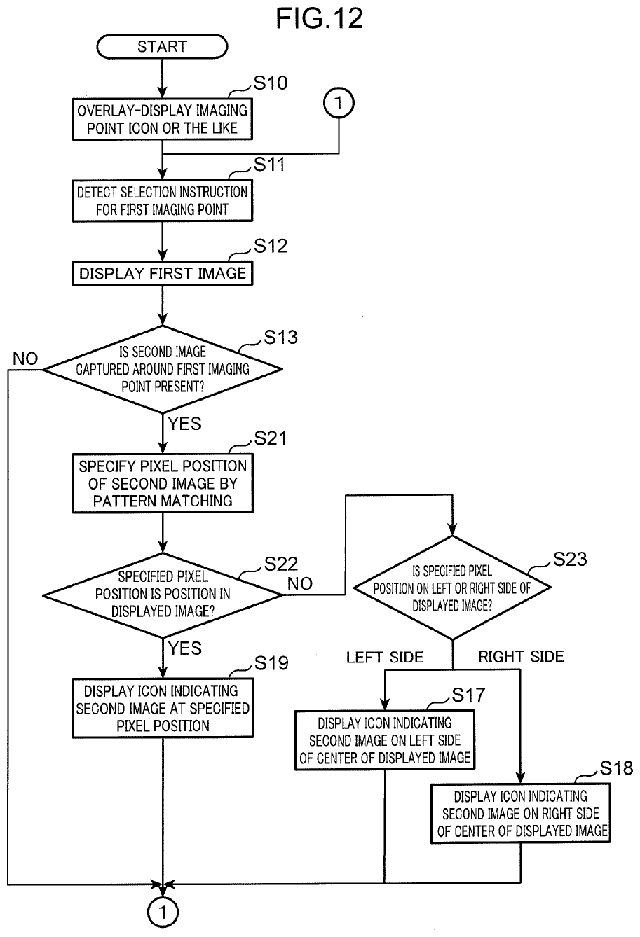

Then, the display control unit 112 causes an image of an arrow, which faces a direction rotated counterclockwise by the third angle λ−(φ₁+φ₂)/2 from the straight line indicating the target position P with the center Q of the icon 324a as a base portion, to be overlay-displayed on the icon 324a as the image 327 indicating the imaging direction of the second image 302.
(2) FIG. 12 is a flowchart illustrating a modification of processing of the information processing system 1. The processing of the information processing system 1 illustrated in FIG. 8 may be changed as illustrated in FIG. 12.

Specifically, when it is determined in step S13 that the second image 302 is associated with a position within the predetermined range with respect to the first imaging point Aa, the processing proceeds to step S21.

In step S21, the display control unit 112 specifies the position of a pixel of the second image 302 in the first image 301 by pattern matching.

Next, in step S22, the display control unit 112 determines whether or not the position (hereinafter, specific pixel position) of the pixel specified in step S21 is included in the displayed image displayed in the detailed image display field 320. When it is determined that the specific pixel position is included in the displayed image (YES in step S22), the processing proceeds to step S19. When it is determined that the specific pixel position is not included in the displayed image (NO in step S22), the processing proceeds to step S23.

In step S19, the display control unit 112 causes the icon 324 indicating the second image 302 to be displayed at the specific pixel position.

In step S23, the display control unit 112 determines whether the specific pixel position is on the left side or the right side with respect to the displayed image displayed in the detailed image display field 320. Specifically, when the distance from the center of the displayed image to the specific pixel position in the left direction is shorter than the distance from the center of the displayed image to the specific pixel position in the right direction, the display control unit 112 determines that the specific pixel position is on the left side with respect to the displayed image. Conversely, when the distance from the center of the displayed image to the specific pixel position in the right direction is shorter than the distance from the center of the displayed image to the specific pixel position in the left direction, the display control unit 112 determines that the specific pixel position is on the right side with respect to the displayed image.

When it is determined in step S23 that the specific pixel position is on the left side with respect to the displayed image (left side in step S23), the processing proceeds to step S17, and when it is determined that the specific pixel position is on the right side with respect to the displayed image (right side in step S23), the processing proceeds to step S18.

According to the present modification, it is possible to appropriately grasp the positional relationship between the displayed image of the first image 301, the displayed image being displayed on the display 23, and the position of the pixel with which the second image 302 is associated. In particular, when the first image 301 is configured as an omnidirectional image, it is possible to appropriately grasp the positional relationship in the elevation angle direction between the displayed image and the second image 302. Therefore, the icon 324 indicating the second image 302 can be appropriately overlay-displayed at the specific pixel position associated with the second image 302 in consideration of the elevation angle direction.
(3) When displaying the first image 301 captured at the first imaging point Aa in the detailed image display field 320, the display control unit 112 may further determine whether or not the first image 301 includes a second imaging point different from the first imaging point Aa among the plurality of imaging points A indicated by the plurality of imaging point icons 201 displayed in the design drawing display field 310. The determination may be implemented by, for example, processing similar to that in step S14 (FIG. 8).

Then, when it is determined that the second imaging point is included, the display control unit 112 may display the information indicating the image captured at the second imaging point at the position corresponding to the second imaging point in the first image 301 displayed in the detailed image display field 320 in a mode different from the information indicating the second image 302 such as the icons 322, 324, and 324a indicating the second image 302 by processing similar to step S15 (FIG. 8). The information indicating the image captured at the second imaging point only needs to include, for example, an icon or the like indicating a direction from the second imaging point toward the imaging point adjacent to the second imaging point.

The present disclosure is useful in the technical field of managing the progress status of construction at a construction site from a remote place.

1. An information processing method in a computer, comprising:
displaying, on a display of a terminal device, a bird's-eye view image on which a plurality of imaging point icons indicating a plurality of imaging points is overlaid; and
displaying, on the display, a first image captured at a first imaging point indicated by a first imaging point icon when selection of the first imaging point icon that is one imaging point icon among the plurality of imaging point icons is detected,
wherein the displaying the first image includes displaying information indicating a second image different from a plurality of images captured at the plurality of imaging points on the first image when the second image is associated with a position within a predetermined range with respect to the first imaging point.

2. The information processing method according to claim 1, wherein the second image is an image captured at a date and time different from a date and time of the plurality of images.

3. The information processing method according to claim 1, wherein the information indicating the second image includes an icon indicating the second image.

4. The information processing method according to claim 1, wherein
the first image is configured as an omnidirectional image, and
the displaying the information indicating the second image includes displaying information indicating the second image on a side closer to a target position that is a position associated with the second image than a center of a displayed image, the displayed image being an image of the first image and being displayed on the display, when the target position is not included in the displayed image.

5. The information processing method according to claim 1, wherein
the first image is configured as an omnidirectional image, and
the displaying the information indicating the second image includes displaying information indicating the second image at a target position that is a position associated with the second image in a displayed image, the displayed image being an image of the first image and being displayed on the display, when the target position is included in the displayed image.

6. The information processing method according to claim 5, wherein the information indicating the second image includes an image indicating an imaging direction of the second image.

7. The information processing method according to claim 4, wherein the displaying the information indicating the second image includes specifying a position of a pixel of the second image in the first image by pattern matching, and specifying the position of the pixel as the target position.

8. The information processing method according to claim 1, further comprising displaying the second image on the display instead of the first image when selection of the information indicating the second image is detected.

9. The information processing method according to claim 1, wherein the information indicating the second image is different depending on whether the second image is configured as an omnidirectional image or a two-dimensional image.

10. The information processing method according to claim 1, further comprising displaying information indicating an image captured at a second imaging point different from the first imaging point among the plurality of imaging points in a mode different from information indicating the second image when an image displayed on the display includes the second imaging point.

11. The information processing method according to claim 1, wherein
the displaying the bird's-eye view image includes further overlaying a position icon indicating a position which the second image is associated with on the bird's-eye view image when the second image is associated with a position within a predetermined range with respect to any imaging point of the plurality of imaging points,
the method further comprising displaying the second image associated with the position indicated by the position icon on the display when selection of the position icon is detected.

12. An information processing device comprising a processor that executes
displaying, on a display of a terminal device, a bird's-eye view image on which a plurality of imaging point icons indicating a plurality of imaging points is overlaid, and
displaying, on the display, a first image captured at a first imaging point indicated by a first imaging point icon when selection of the first imaging point icon that is one imaging point icon among the plurality of imaging point icons is detected,
wherein the displaying the first image includes displaying information indicating a second image different from a plurality of images captured at the plurality of imaging points on the first image when the second image is associated with a position within a predetermined range with respect to the first imaging point.

13. A non-transitory computer readable storage medium storing an information processing program causing a computer to execute
displaying, on a display of a terminal device, a bird's-eye view image on which a plurality of imaging point icons indicating a plurality of imaging points is overlaid, and
displaying, on the display, a first image captured at a first imaging point indicated by a first imaging point icon when selection of the first imaging point icon that is one imaging point icon among the plurality of imaging point icons is detected,
wherein the displaying the first image includes displaying information indicating a second image different from a plurality of images captured at the plurality of imaging points on the first image when the second image is associated with a position within a predetermined range with respect to the first imaging point.
